(19) United States
(12) Patent Application Publication
(10) Pub. No.: US 2014/0274009 A1
(43) Pub. Date: Sep. 18, 2014

(54) LOCATION-AWARE NETWORK SELECTION

(71) Applicant: QUALCOMM INCORPORATED, San Diego, CA (US)

(72) Inventors: Ju-Yong Do, Palo Alto, CA (US); Mark L. Moeglein, Ashland, OR (US)

(73) Assignee: QUALCOMM INCORPORATED, San Diego, CA (US)

(21) Appl. No.: 13/796,836

(22) Filed: Mar. 12, 2013

(51) Int. Cl. H04W 52/02

(52) U.S. Cl. CPC H04W 52/0209
USPC 455/418; 455/435.2

(57) ABSTRACT

Systems, apparatus and methods in a mobile device for saving power by powering down all transceivers not carry traffic are presented. The traffic may be voice and/or data traffic. A mobile device may select single transceiver to carry voice traffic and the same or different transceiver to carry data traffic. A mobile device first determines its position (e.g., a coarse position estimate) then consults a database or map to determine which networks are theoretically available. The mobile device executes a rule against the theoretically available networks to select the single network, then enables the transceiver for the one network to determine if the network is actually available for use. If the database inaccurately states a network is available from a current position but the transceiver shows that the network is actually not actually available, a next network from the database or map and corresponding transceiver are selected.

### CROSS-REFERENCE TO RELATED APPLICATIONS

This is the first application filed for the present technology.

### BACKGROUND

I. Field of the Invention

This disclosure relates generally to systems, apparatus and methods for exchanging data in a wireless network, and more particularly to selecting a wireless network based on an estimated position.

II. Background

A mobile device often searched for a home network and other known networks if not currently connected to the network. However, blindly searching for a network consumes mobile device power and radio bandwidth. Some mobile devices have a sequence of networks in their search list and stop at the first available network found. Using a first network found when other networks are available may result in unnecessary costs of communicating user data traffic and/or using a sub-optimal data rate when a cheaper or free network is available but not yet detected. A means is needed to reduce battery consumption and radio bandwidth expended on fruitless search efforts and to select a best network available without an exhaustive search.

### BRIEF SUMMARY

Systems, apparatus and methods in a mobile device for saving power by powering down all transceivers not carrying traffic are presented. The traffic may be voice and/or data traffic. A mobile device may select single transceiver to carry voice traffic and the same or different transceiver to carry data traffic. A mobile device first determines its position (e.g., a coarse position estimate) then consults a database or map to determine which networks are theoretically available. The mobile device executes a rule against the theoretically available networks to select the single network, and then enables the transceiver for the one network to determine if the network is actually available for use. If the database inaccurately states a network is available from a current position but the transceiver shows that the network is actually not actually available, a next network from the database or map and corresponding transceiver are selected.

According to some aspects, disclosed is a method for selecting a network in a mobile device, the method comprising: determining a position estimate of the mobile device, wherein the mobile device comprises a plurality of transceivers configured to communicate over a plurality of networks; accessing a radio resource map for the position estimate, wherein the radio resource map contains a cost and a data rate at the position estimate for each network in the plurality of networks; selecting the network from the plurality of networks and a single transceiver from the plurality of transceivers based on accessing the radio resource map; and communicating traffic over the single transceiver.

According to some aspects, disclosed is a method for selecting a network in a mobile device, the method comprising: determining a position estimate of the mobile device, wherein the mobile device comprises a plurality of transceivers configured to communicate over a plurality of networks; estimating a future position estimate of the mobile device; accessing a radio resource map for the future position estimate of the mobile device, wherein the radio resource map contains a cost and a data rate at the position estimate and at the future position estimate for each network in the plurality of networks; selecting the network from the plurality of networks and a single transceiver from the plurality of transceivers based on accessing the radio resource map; and communicating traffic over the network.

According to some aspects, disclosed is a mobile device for selecting a network, the mobile device comprising: a positioning engine configured to provide a position estimate; a radio resource map coupled to the positioning engine, wherein the radio resource map comprises a cost and a data rate at the position estimate for each of a plurality of networks; a plurality of transceivers coupled to the positioning engine and configured to communicate with the plurality of networks; and a processor coupled to the positioning engine, to the radio resource map and to the plurality of transceivers, and configured to provide instructions to the positioning engine to enable and disable the plurality of transceivers based on the position estimate and the radio resource map.

According to some aspects, disclosed is a mobile device for selecting a network, the mobile device comprising: means for determining a position estimate of the mobile device, wherein the mobile device comprises a plurality of transceivers configured to communicate over a plurality of networks; means for accessing a radio resource map for the position estimate, wherein the radio resource map contains a cost and a data rate at the position estimate for each network in the plurality of networks; means for selecting the network from the plurality of networks and a single transceiver from the plurality of transceivers based on accessing the radio resource map; and means for communicating traffic over the single transceiver.

According to some aspects, disclosed is a mobile device for selecting a network, the mobile device comprising a processor and a memory wherein the memory includes software instructions to: determine a position estimate of the mobile device, wherein the mobile device comprises a plurality of transceivers configured to communicate over a plurality of networks; access a radio resource map for the position estimate, wherein the radio resource map contains a cost and a data rate at the position estimate for each network in the plurality of networks; select the network from the plurality of networks and a single transceiver from the plurality of transceivers based on accessing the radio resource map; and communicate traffic over the single transceiver.

According to some aspects, disclosed is a non-transitory computer-readable storage medium including program code stored thereon, for selecting a network, the non-transitory computer-readable storage medium comprising program code to: determine a position estimate of a mobile device, wherein the mobile device comprises a plurality of transceivers configured to communicate over a plurality of networks; access a radio resource map for the position estimate, wherein the radio resource map contains a cost and a data rate at the position estimate for each network in the plurality of networks; select the network from the plurality of networks and a single transceiver from the plurality of transceivers based on accessing the radio resource map; and communicate traffic over the single transceiver.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 shows modules of a mobile device, in accordance with some embodiments of the present invention.

FIG. 2 illustrates a coverage map, in accordance with some embodiments of the present invention.

FIG. 3 illustrates a data rate contour map, in accordance with some embodiments of the present invention.

FIG. 4 illustrates a data rate cost map, in accordance with some embodiments of the present invention.

FIG. 5 illustrates a radio resource table for a current estimated position (x,y), in accordance with some embodiments of the present invention.

FIG. 6 shows a comparison module, in accordance with some embodiments of the present invention.

FIGS. 7-11 show available and a selected network along a path, in accordance with some embodiments of the present invention.

FIG. 12 shows a method for selecting a data network for carrying data traffic, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

FIG. 1 shows modules of a mobile device, in accordance with some embodiments of the present invention. The positioning engine 100 controls various transceivers and receivers by enabling and disabling the transceivers and receivers as necessary based on determined position. For example, positioning engine 100 enables a GPS receiver to determine an estimated position. Alternatively, the position estimate may be derived from a different transceiver (e.g., enabling an LTE transceiver and using known base station positioning techniques) or sensor (e.g., accelerometer feeding a dead reckoning algorithm). A position estimate may be made at an earlier time and stay valid while sensors indicate the mobile device has not moved or moved less than a threshold distance. The positioning engine 100 accesses a radio resource map 110 or database indexed by positions estimate. That is, the position estimate is used as an input parameter to extract available radio resources from the radio resource map 110 at the current position estimate.

Generally, positioning engine 100 may need only coarse position estimate and thus may be able to maintain a valid position estimate longer based only on the currently operating transceiver(s). For example, if an LTE transceiver is currently being used, a coarse position estimate may be given by the cellular identifier (Cell ID). Therefore. a coarse position estimate may be updated and maintained using various received measurements or parameters (e.g., a Cell ID, a Cell ID and its corresponding SNR, RSSI and/or RTT, or a WiFi MAC address) received at an enabled transceiver (e.g., a single enable transceiver for voice traffic and/or a single transceiver for data traffic). Thus, a GPS or other GNSS receiver does not need to be necessarily powered up to obtain a coarse position estimate. Instead, a coarse position estimate may be formed from signals for the transceiver carrying voice traffic and/or the transceiver carrying data traffic.

However, the positioning engine may sometimes need to turn on and off any other set of transceivers or sensors if they are needed to update its position estimate

The radio resource map 110 may be stored locally at the positioning engine 100 or remotely from the mobile device, for example, at a location server. The radio resource map 110 indicates what networks should be available at the current estimated position (as shown in FIG. 2). A radio resource map 110 may exist for data networks and a separate radio resource map 110 may exist for voice networks. The radio resource map 110 may also have a data rate contour map (as shown in FIG. 3), which indicates a maximum data rate for each network. A maximum data rate may decrease as the mobile device leaves a center area of a base station, for example, positioned equally between two base stations. The radio resource map 110 may also include a cost map or table (as shown in FIG. 4), which indicates an amount a user will be charged for data throughput or bandwidth. The cost may include a cost per data quantity ($/MB) for at least one network. For example, the amount charged may be tiered such that the first X megabytes cost a certain amount per time period (e.g., per day or month), the next Y megabytes per time period cost a different amount, and so on. For example, the first tier may be free or cost a nominal amount and excessive usage in the next tier may cost more. Alternatively, the first tier may cost more than the second tier and so on such that a higher volume of data traffic cost less than a lower volume. The radio resource map 110 may also contain a rate of power consumption for each network (as shown in FIG. 5).

The radio resource map 110 may be developed based on crowd sourcing coverage, data rate, cost and/or power consumption information from a variety of mobile devices over time. The radio resource map may also be developed from RF simulations based on a known radio resource location (e.g., a cell tower location or WiFi AP location) and/or known environment information (e.g., location dimension of buildings, location of a mountain). The radio resource map 110 may be provided from the location server to a mobile device and any discrepancies returned to the location server to update the radio resource map 110. Cost and/or power consumption may be specific to a particular mobile device and may be provided directly by a user, network provider or manufacturer. The positioning engine 100 determines which transceiver (also referred to as a radio) best meets the requirements of a user of the mobile device. For example, the positioning engine 100 may combine two or more elements of a radio resource map 110 for each network to form a score and compare network scores (as shown in FIG. 6), thereby determining a best network for the user. The positioning engine 100 may optionally disable unneeded receivers and transceivers based on determined position.

Various networks are available to the mobile device as it travels along a path (as shown in FIG. 7). Depending on rules and criteria (coverage, available data rate, costs and/or power consumption), a particular transceiver is used to transfer user traffic across a selected network (as shown in FIGS. 7-11). Finally, a mobile device selects a data network for carrying data traffic on a network from a plurality of networks (as shown in FIG. 12).

In FIG. 1, a positioning engine 100 may be coupled in a star configuration to various receivers and transceivers, including any of one or more GNSS transceivers (e.g., a GPS receiver 202), a WiFi transceiver 204, and one or more cellular transceivers (e.g., an LTE transceiver 206, a CDMA transceiver 208 and a GSM transceiver 210). Hereinafter, the terms receivers and transceivers are used in their plural forms even though an embodiment may comprise only one receiver with only one transceiver, or alternatively, no separate receivers and two transceivers. Sometimes one or more receiver(s) and transceiver(s) are abbreviated with the term radios. The positioning engine 100 is located at in the middle of the receivers and transceivers to form a star configuration such that the positioning engine 100 enables and disables the receivers and transceivers as necessary based on data from the radio resource map 110. Once enabled and locked to a remote transmitter, a receiver or transceiver communicates data traffic with the receiver or transceiver. Other radios are left unused and disabled. If the radio resource map 110 erroneously states a network signal is available but the network is unavailable at a current position, the mobile device may consult the radio resource map 110 and rules to find the next best radio to use. The mobile device may also communicate the erroneous coverage indication to the location server, for example, at a later convenient time.

The radio resource map 110 may include one, two or more of a coverage map, a data rate contour map, a signal strength map, a cost map (or table), and a power consumption map (or table) for data and/or voice. For example, the radio resource map 110 may include a coverage map for data, a coverage map for voice, a data rate contour map for data, a data rate contour map for voice, a cost map for data, a cost map for voice, and a power consumption map. A power consumption map may also be derived from a signal strength map, where more power may be required in low signal strength situations, both for receiving and transmitting. The signal strength map may provide an aggregated estimate of best signal strengths from a plurality of transceivers of a given network, or it may provide a separate signal strength map for each transceiver.

The mobile device saves power by powering down one or more transceivers not carrying traffic, which may be voice and/or data traffic. As mentioned above, the mobile device comprises a positioning engine 100, an optional GNSS receiver (e.g., GPS receiver 202) and a plurality of transceivers (204-210) for a corresponding plurality of networks. The GNSS receiver and the plurality of transceivers (204-210) are referred to as radios, which are each coupled to the positioning engine 100. The positioning engine 100 provides a position estimate. The position estimate may be a Cell ID or the like from a powered up radio. The mobile device also includes a radio resource map coupled to the positioning engine. In some embodiments, the radio resource map comprises a cost and a data rate at the position estimate for each of the plurality of networks. The radio resource map may also include a power consumption rate for the data rate over the plurality of networks. The radio resource map may include at least one or two of: a data rate for each of the plurality of networks at the position estimate; a cost for each of the plurality of networks at the position estimate; and a power consumption for each of the plurality of networks at the position estimate.

FIG. 2 illustrates a coverage map, in accordance with some embodiments of the present invention. An example path is shown through several overlapping coverage areas. A path begins at point A and ends at point B. During a first zone, the mobile device travelling along the path has coverage with GPS and CDMA networks. Therefore, based on position, the GPS and CDMA receivers may be enabled if needed as a result of user rules. Other receivers most likely cannot receive an adequate signal from their respective networks, so the positioning engine 100 may leave other radios disabled. Even though radios show coverage in the radio resource map 110, one or more or all of these radios may be disabled based on user rule.

Within a second zone along the example path, GPS is lost for a short time. During the next zones, the mobile device travels through WiFi coverage, and then LTE coverage then loses CDMA coverage. Soon WiFi and then LTE coverage is lost until at point B when the mobile device only has GPS coverage.

The positioning engine 100 may disable a radio not expected to have coverage as indicated by the radio resource map 110. Before disabling a radio, the positioning engine 100 may send a warning to the unit using the radio that the radio will soon go off-line and be disabled. Again, even though coverage exists according to the radio resource map 110, the positioning engine 100 may not enable a radio if unnecessary by the user rules. If coverage is provided by both a CDMA network and an LTE network, a first radio may be enabled while a second radio is left disabled. For example, if CDMA coverage is intermit along the path, perhaps only the LTE radio will be enabled and the CDMA will remain disabled. If the CDMA provides a low cost or free data plan, a CDMA radio may be selected over an LTE radio. Depending on the available networks from the radio resource map 110 and user rules, the positioning engine 100 determines which radio or radios, if any, to enable and which radios to leave disabled.

FIG. 3 illustrates a data rate contour map, in accordance with some embodiments of the present invention. The data rate contour map may overlap with a coverage map. That is, the coverage map may be formed from the data rate contour map based on a certain minimum threshold data rate.

For each provider at each location from a base station, the mobile station may acquire a predictable maximum data rate. For example, near a base station, a mobile station exchanges data at a rate of 1 Mbps. At a medium distance from the base station, the predictable maximum data rate is 0.1 Mbps. At a longer distance from the base station before being handed off to or acquiring another base station in the same network, the predictable maximum data rate is 0.01 Mbps. The database in the radio resource map 110 may provide a contour map for one or more base stations for one or more networks. The database may have a different data rate for upstream traffic (from the mobile station to the network) than for downstream traffic (from the network to the mobile station). That is, a first contour map may exist for upstream traffic and a second contour map may exist for downstream traffic.

FIG. 4 illustrates a data rate cost map, in accordance with some embodiments of the present invention. Similar to the contour map, a cost map provides a monetary cost for exchanging data associated with a given position. Alternatively, the cost map may be in the form of a table (e.g., a table for a network). Often the cost is tiered or constant within a network and independent of location as long as the network provides coverage at that location. For example, a cost map may show that free data traffic is attainable from a WiFi hotspot when given coverage by the WiFi hotspot. A low cost (a set $x/MB) is provided by a particular macrocell network (e.g., providing GPRS). A high cost (a set $y/MB) is provided by another macrocell network (e.g., providing GSM). The cost rate may be constant or tiered with volume per duration. For example, data traffic may cost more after an allotment is “used up.” Alternatively, data traffic may cost more if only a small amount is purchased and may cost less in bulk. A cost map may have a fix set of prices per network and may be associated with a coverage map. Alternatively, a cost map may include costs for each network available at different locations.

A radio resource map 110 may also include a power consumption map or table. The power consumption map may indicate a power consumption rate for each network being used at a maximum data rate when at a particular position. Alternatively, a power consumption map may be a fix table of various power consumption rates for different data rates for each network and may be associated with a data rate map and/or coverage map.

FIG. 5 illustrates a radio resource table for a current estimated position (x,y), in accordance with some embodiments of the present invention. For example, at one particular point, the power consumption map indicated 8 Joules per time unit are consumed when operation on a GSM network at full capacity, 12 Joules per time unit are consumed when operation on a CDMA network at full capacity, 2 Joules per time unit are consumed when operation on a WiFi network at full capacity, and no coverage is provided at the particular location for a GPRS network. The power consumption rate accounts for a radio's use and a maximum data rate when communicating with a particular network. In the example shown, at the particular location, GSM provides a maximum data rate of 22.4 Kbps (from the data rate map) at a free cost (from the cost map or table) at 8 Joules per time unit. Similarly, CDMA provides a 2.0 Mbps maximum data rate at a cost of $2.05/MB at the particular location for the next bits consumed at 12 Joules per time unit. WiFi provides 7.2 Mbps at no cost and a power consumption rate of 2 Joules per time unit.

FIG. 6 shows a comparison module, in accordance with some embodiments of the present invention. From the data rate map, cost map and power consumption rate map, a table of potential radio resources may be formed for any position estimate (x,y). The various maps may be quantizing into few or more levels and each level may be given an arbitrary value depending on a user's preferences thus potentially weighing one map or parameter over another. A number of levels and/or values may differ between voice and data traffic. For example, the values assigned to a cost map for data traffic may be higher than values assigned for voice traffic.

Each map may be quantized for a grid or location into two or more ranges. For example, the cost map is quantized into ten levels where level 10 represents no cost per megabyte, level 9 represents up to $0.10/Mb, level 8 represents up to $0.20/Mb, level 7 represents up to $0.30/Mb, and so on until level 1 represents up to $0.90/Mb, level 0 represents more than $0.90/Mb.

Similarly, the data rate map is quantized into five levels where level 10 represents a data rate of 100 Mbps, level 9 represents a data rate of 10 Mbps, level 8 represents a data rate of 1 Mbps, level 7 represents a data rate of 0.1 Mbps, level 6 represents a data rate of 0.01 Mbps, and a level 0 may represent no coverage.

A power consumption map may be quantized into five levels where level 10 represents a power consumption that is very low, level 9 represents a power consumption that is low, level 8 represents a power consumption that is medium, level 7 represents a power consumption that is high, and level 6 represents a power consumption that is very high.

Each of the quantized values (from the cost map, data rate map and power consumption map) are provided. Next, a summer 118 adds together the levels to form a score for a particular network (e.g., a score for network A). The process may be repeated to find a score for each network (e.g., a score for networks B and C). A comparator 120 selects the maximum score to indicate which network has parameters at a particular position that is most important to a user.

Instead of quantized numerical value, a radio resource map 110 (e.g., the cost map, data rate map and power consumption map) may be represented by a color. Maps are often found in popular picture formats, such as in a JPEG format. Each data type may be assigned to a different spectrum in the RGB scale. For example, a red spectrum encodes cost, a green spectrum encodes data rate, and a blue spectrum encodes power consumption. In this case, a single JPEG file contains three types of radio resource information together (e.g., the cost map, data rate map and power consumption map). Additional resource information may be encoded into separate JPEG file(s). Also, two fields may be combined into a single color spectrum. A red spectrum, for example, with 8 bits of data may be split. For example, bits 0 to 3 may represent a network quality or voice quality and bits 4 to 7 may represent data rate. Encoding the radio resource map 110 as a JPEG or equivalent picture file or picture format compactly encodes the radio resource map 110.

For example, a GSM network may score a level 5 for cost, a level 8 for data rate, and a power consumption of level 8 ending is a combined score of 21. Similarly, a CDMA network may have a combined un score of 19 and a WiFi network may have a combined score of 28. The comparator 120 then compares the values 21, 19 and 28 to decide the WiFi network (with a score of 28) should be selected at a particular position where all three networks are available. This score may differ a hundred meters away, for example, if data rate changes at the new position.

Table 1 shows another example priority system.

TABLE 1

| | Weight per criteria | | | | | | | |
|---|---|---|---|---|---|---|---|---|
| | | | | | Power savings mode (e.g., | | | |
| | Best performance | | | | remaining battery below 20%) | | | |
| | Voice | Data | Voice + | | Voice | Data | Voice + | |
| Criteria | call | call | data | Idle | call | call | data | Idle |
| Voice cost | 3 | 1 | 3 | 1 | 3 | 2 | 3 | 1 |
| Voice | 10 | 2 | 10 | 4 | 6 | 2 | 6 | 2 |
| quality | | | | | | | | |
| Voice | 6 | 1 | 6 | 4 | 10 | 5 | 10 | 10 |
| power | | | | | | | | |
| con- | | | | | | | | |
| sumption | | | | | | | | |
| Data cost | 1 | 3 | 3 | 1 | 2 | 3 | 3 | 1 |
| ($/MB) | | | | | | | | |
| Data rate | 2 | 10 | 10 | 8 | 2 | 6 | 6 | 2 |
| Data | 1 | 6 | 6 | 8 | 5 | 10 | 10 | 10 |
| power | | | | | | | | |
| con- | | | | | | | | |
| sumption | | | | | | | | |

In Table 1, a user selects from one of two criteria or rules: “I want the best performance” shown on the left or “I want to save the most power” shown or the right. The rule may be for all battery levels or may be enabled when a battery level is below a certain threshold (e.g., less than 20%). Assume the user has selected power savings over performance. Also assume a user is idle and is looking for a voice network from a plurality of networks. From the table (top half of far left column), voice cost is weighted by 1, voice quality is weighted by 2 and voice power consumption is weighted by 10 (from the far right column). In FIG. 6, the cost level is weighted by 1, the data rate level is weighted by 2, and the power consumption level is weighted by 10 before being summed by summer 118. In the example for a particular network, the levels are 5, 8 and 8, respectively. Weighting and combining a score for the particular network is 5*1+8*2+8*10=101 or a weighted score of 101. The same weighting is used to score other networks. The scores for each network are fed to a comparator 120, which selects the network with the highest score and thus a transceiver is selected for the network with the highest score.

When a user is going to make a voice call, table shows (top half of fourth to final column) a cost level is weighted by 3, a data rate level is weighted by 6, and a power consumption level is weighed by 10. Using the same example levels of 5, 8 and 8, the weighted score for a particular network is 5*3+8*3+8*10=119. As before, scores for this particular network and each network, with coverage at a rough location, are fed to a comparator 120, which selects the network with the highest score and thus a transceiver is selected for the network with the highest score.

Assume other user selects “best performance” and is searching for a network for data traffic (shown as a “data call”). From the table, a cost level is weighted by 3, a data rate level is weighted by 10, and a power consumption level is weighted by 6. Using the same example levels of 5, 8 and 8, the weighted score for a particular network is 5*3+8*10+8*6=157. Scores for each network are fed to comparator 120, which selects the network and a transceiver associated with the highest score.

Alternatively, a set of rules may be implemented to decide which network to use. One set of rules may apply to voice traffic while a different or partially overlapping set of rules may apply to data traffic. For example, voice rules may include rules based on a minimum voice call quality, a maximum voice call cost and/or a maximum voice call power consumption. A similar set of data rules may include minimum data rate, maximum data cost and/or data call power consumption. The sum of weights may vary and the values of the table do not need to be normalized because a comparator 120 is used to compare relative values.

A simple set of rules may be offered to a user. A user may configure and prioritize a parameter, For example, a user may select a rule that states “I prefer to save money” over “I want the fastest data rate.” Another example rule may state “I prefer to save battery power” or “I prefer to save battery power when the battery is half full or less.” Two rules may be combined, for example, a rule may state “I prefer to save money on data traffic and ensure voice calls.”

A rule may prioritize cost, data rate, power consumption and/or other factors. For example, a rule may be to use a free network if available, and if not, use a network providing the highest data rate. A rule may be to select a network with the widest range of coverage (i.e., continuous span of coverage) along a predicted or proposed path. A rule may be to select networks solely base on cost. A rule may be to select a network providing the highest data rate. A rule may be to select a network that is cheapest that also provides a threshold data rate.

A processor may act as a rules processor, summer 118, and comparator 120 described above, or a means for selecting a network.

FIGS. 7-11 show available and a selected network along a path, in accordance with some embodiments of the present invention. In FIG. 7, a mobile device travels along an example path with different network coverage in seven different zones (first zone in the path to a seventh zone in the path): (1) just GSM network coverage; (2) both GSM and CDMA; (3) just CDMA; (4) both CDMA and WiFi; (5) just WiFi; (6) both GSM and WiFi; and (7) all three—GSM, CDMA and WiFi. Depending where along the path the mobile device finds itself, the mobile device may have two or three networks from which to select. A selection from two or more available networks from either a maximum score or a rule. FIGS. 8-11 are illustrated assuming the coverage shown in FIG. 7.

In FIG. 8, a rule prioritized cost from a cost map over other factors such as data rate and power consumption. In this example, network A is a free WiFi network, Network B is a CDMA network, which cost the least amount of cents per megabyte, and Network C is a GSM network and is most expensive. As the mobile travels along the example path with such a rule, a GSM network (Network C) is selected in a first zone, a CDMA network (Network B) is selected in zones 2 and 3, and a WiFi network (Network A) is selected in zones 4-7. In this example, the various networks operate with different radio technologies or air interface (WiFi, CDMA and GSM). In other examples, the various networks may operate with overlapping technologies (e.g., both Network A and Network B using GSM). In practice, a network's cost and coverage can vary between different carriers using the same air interface.

In FIG. 9, a rule prioritized throughput above cost and power consumption. In this example and at this particular location, CDMA provides the fastest throughput followed by WiFi. A GSM network is selected in zone 1, a CDMA network is selected in zones 2-4, a WiFi network is selected in zones 5-6, and finally, the CDMA network is selected again in zone 7.

In FIG. 10, a rule prioritized a user travel speed. For example, assume WiFi is not selected when traveling faster than a threshold speed (i.e., current speed>threshold). Not selecting WiFi networks may minimize transitions between networks. Similarly, when a path being traveled indicates a mobile device is partway from leaving a preferred network, the mobile device may transition to the suboptimal network early in order to have a smooth transition. A mobile device traveling faster than the threshold speed selects a GSM network in zone 1. Partway through zone 2 the mobile device transitions from the GSM network to a CDMA network through the reminder of zone 2, zone 3 and zone 4. The mobile device has no coverage during zone 5. GSM coverage begins again in zone 6 and partially through zone 7 where a transition occurs to the CDMA network. Speed or previous position estimates also may be used to determine a future position estimate. A mobile device may use the future position estimate when accessing a radio resource map to determine which network to use. In some embodiments, the radio resource map contains a cost and a data rate at the position estimate and at the future position estimate for each network in a plurality of networks. An expected route may also be used to determine a future position estimate. The expected route may be derived from a history of routes the device has already followed, for example. Alternatively, an expected route may be associated with a pre-planned route, for example, from a mapping application.

A rule may request smooth transition of voice and/or data traffic when possible. A smooth transition from one network to another network may be based on a predicted switch of networks. That is, a first network is being used but is predicted to drop unless a second network is used. By predicting a transition, two networks may be prepared in advance and thus, the transition is made smoother than a system without predicted forced transition. Using predictions, at least some dropped calls may be avoided.

The decision rule may be based on: (1) a user context, such as call status (e.g., “in a voice call,” “in a data call” or “no call activity”); and/or (2) a level of remaining battery power. Such user context may be used to adjust the weighting between a decision rule or even disallow a certain network change. For example, if currently in a voice call, do not switch to other network until call is finished. If in a data call, do allow switching to a better data network as long as smooth data traffic re-routing is supported.

In FIG. 11, a network is selected based power consumption. For example, assume operating in an WiFi network provides a lower power consumption than operating in a GSM network. During travel along the path, GSM is selected from zone 1 to 2, CDMA is selected during zone 3, and then WiFi is selected.

FIG. 12 shows a method 400 for selecting a data network for carrying data traffic, in accordance with some embodiments of the present invention. The method 400 in a mobile device selects a data network to carry data traffic on a selected network from a plurality of networks comprising a first network and a second network. At 410, a processor determines a position estimate. At 420, the processor accesses a radio resource map for the position estimate, wherein the radio resource map comprises a cost and a data rate at the position estimate for each of the first network and the second network. At 430, the processor selects a single network from the plurality of networks based on the radio resource map. In some cases, the processor selects a single network for data traffic and a single network for voice traffic. In some embodiments, a VoIP call (voice or a data path), for example, through WiFi, might be free or inexpensive but have lower voice quality while a CDMA call might cost more but with a higher voice quality.

At 440, the processor communicates data and/or voice over the single network. Alternatively, the processor communicates data over a first single network and voice over a second single network. For example, a voice call is communicated through GSM while data traffic is communicated through WiFi.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, non-volatile, non-transitory, and is not to be limited to any particular type of non-transitory memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method for selecting a network in a mobile device, the method comprising:
determining a position estimate of the mobile device, wherein the mobile device comprises a plurality of transceivers configured to communicate over a plurality of networks;
accessing a radio resource map for the position estimate, wherein the radio resource map contains a cost and a data rate at the position estimate for each network in the plurality of networks;
selecting the network from the plurality of networks and a single transceiver from the plurality of transceivers based on accessing the radio resource map; and
communicating traffic over the single transceiver.

2. The method of claim 1, wherein the radio resource map is encoded into a picture format.

3. The method of claim 1, wherein the cost comprises a cost per data quantity for at least one of the plurality of networks.

4. The method of claim 1, wherein the radio resource map further contains a power consumption rate for at least one of the plurality of networks.

5. The method of claim 1, wherein the radio resource map further contains a signal strength map containing a signal strength at the position estimate for at least one of the plurality of networks.

6. The method of claim 1, wherein selecting the network comprises determining the network based on:
the data rate at the position estimate for each of the plurality of networks;
the cost; and
a power consumption rate.

7. The method of claim 1, wherein selecting the network comprises determining the network based on at least two of:
the data rate at the position estimate for each network in the plurality of networks;
the cost; and
a power consumption rate.

8. The method of claim 1, wherein the radio resource map further comprises a network quality map containing a network quality at the position estimate for at least one of the plurality of networks.

9. The method of claim 1, wherein selecting the network comprises determining the network based on at least two networks of the plurality of networks providing coverage to the mobile device at the position estimate.

10. The method of claim 1, wherein selecting the network comprises determining the network based on the data rate at the position estimate for each of the plurality of networks.

11. The method of claim 1, wherein selecting the network comprises determining the network based on the cost.

12. The method of claim 1, wherein selecting the network comprises determining the network based on a power consumption rate.

13. The method of claim 1, further comprising:
determining a speed of the mobile device;
wherein selecting the network is further based on the speed.

14. The method of claim 1, further comprising enabling the single transceiver based on selecting the network.

15. The method of claim 1, further comprising disabling each of the plurality of transceivers except the single transceiver.

16. The method of claim 1, wherein the traffic comprises voice traffic.

17. A method for selecting a network in a mobile device, the method comprising:
determining a position estimate of the mobile device, wherein the mobile device comprises a plurality of transceivers configured to communicate over a plurality of networks;
estimating a future position estimate of the mobile device;
accessing a radio resource map for the future position estimate of the mobile device, wherein the radio resource map contains a cost and a data rate at the position estimate and at the future position estimate for each network in the plurality of networks;
selecting the network from the plurality of networks and a single transceiver from the plurality of transceivers based on accessing the radio resource map; and
communicating traffic over the network.

18. The method of claim 17, further comprising:
determining a speed of the mobile device;
wherein selecting the network is further based on the speed.

19. The method of claim 17, further comprising enabling the single transceiver based on selecting the network.

20. The method of claim 17, further comprising disabling each of the plurality of transceivers except the single transceiver.

21. The method of claim 17, wherein selecting the network comprises determining the network based on at least two of:
the data rate at the position estimate for each network in the plurality of networks;
the cost; and
a power consumption rate.

22. A mobile device for selecting a network, the mobile device comprising:
a positioning engine configured to provide a position estimate;
a radio resource map coupled to the positioning engine, wherein the radio resource map comprises a cost and a data rate at the position estimate for each of a plurality of networks;
a plurality of transceivers coupled to the positioning engine and configured to communicate with the plurality of networks; and
a processor coupled to the positioning engine, to the radio resource map and to the plurality of transceivers, and configured to provide instructions to the positioning engine to enable and disable the plurality of transceivers based on the position estimate and the radio resource map.

23. The mobile device of claim 22, wherein the radio resource map is encoded into a picture format.

24. The mobile device of claim 22, wherein the radio resource map comprises a cost per data quantity for at least one of the plurality of networks.

25. The mobile device of claim 22, wherein the radio resource map further contains a power consumption rate for at least one of the plurality of networks.

26. The mobile device of claim 22, wherein the radio resource map comprises at least two of:
the data rate at the position estimate for each network in the plurality of networks;
the cost; and
a power consumption rate.

27. A mobile device for selecting a network, the mobile device comprising:
means for determining a position estimate of the mobile device, wherein the mobile device comprises a plurality of transceivers configured to communicate over a plurality of networks;
means for accessing a radio resource map for the position estimate, wherein the radio resource map contains a cost and a data rate at the position estimate for each network in the plurality of networks;
means for selecting the network from the plurality of networks and a single transceiver from the plurality of transceivers based on accessing the radio resource map; and
means for communicating traffic over the single transceiver.

28. The mobile device of claim 27, wherein the cost comprises a cost per data quantity for at least one of the plurality of networks.

29. The mobile device of claim 27, wherein the radio resource map further contains a power consumption rate for at least one of the plurality of networks.

30. The mobile device of claim 27, wherein the means for selecting the network comprises means for determining the network based on at least two networks of the plurality of networks providing coverage to the mobile device.

31. The mobile device of claim 27, wherein the means for selecting the network comprises means for determining the network based on at least two of:
the data rate at the position estimate for each network in the plurality of networks;
the cost; and
a power consumption rate.

32. The mobile device of claim 27, further comprising means for enabling the single transceiver based on selecting the network.

33. The mobile device of claim 27, further comprising means for disabling each of the plurality of transceivers except the single transceiver.

34. A mobile device for selecting a network, the mobile device comprising a processor and a memory wherein the memory includes software instructions to:
determine a position estimate of the mobile device, wherein the mobile device comprises a plurality of transceivers configured to communicate over a plurality of networks;
access a radio resource map for the position estimate, wherein the radio resource map contains a cost and a data rate at the position estimate for each network in the plurality of networks;
select the network from the plurality of networks and a single transceiver from the plurality of transceivers based on accessing the radio resource map; and
communicate traffic over the single transceiver.

35. The mobile device of claim 34, wherein the cost comprises a cost per data quantity for at least one of the plurality of networks.

36. The mobile device of claim 34, wherein software instructions to select the network comprises software instructions to determine the network based on the cost.

37. The mobile device of claim 34, further comprising software instructions to enable the single transceiver based on selecting the network.

38. The mobile device of claim 34, further comprising software instructions to disable each of the plurality of transceivers except the single transceiver.

39. A non-transitory computer-readable storage medium including program code stored thereon, for selecting a network, the non-transitory computer-readable storage medium comprising program code to:
determine a position estimate of a mobile device, wherein the mobile device comprises a plurality of transceivers configured to communicate over a plurality of networks;
access a radio resource map for the position estimate, wherein the radio resource map contains a cost and a data rate at the position estimate for each network in the plurality of networks;
select the network from the plurality of networks and a single transceiver from the plurality of transceivers based on accessing the radio resource map; and
communicate traffic over the single transceiver.

40. The non-transitory computer-readable storage medium of claim 39, wherein the cost comprises a cost per data quantity for at least one of the plurality of networks.

41. The non-transitory computer-readable storage medium of claim 39, wherein program code to select the network comprises program code to determine the network based on the cost.

42. The non-transitory computer-readable storage medium of claim 39, further comprising program code to enable the single transceiver based on selecting the network.

43. The non-transitory computer-readable storage medium of claim 39, further comprising program code to disable each of the plurality of transceivers except the single transceiver.
